(19) United States
(12) Patent Application Publication
(10) Pub. No.: US 2025/0050748 A1
(43) Pub. Date: Feb. 13, 2025

(54) Ethanol agnostic range extender systems for commercial vehicles

(71) Applicants: Xubin Song, Bloomfield Hills, MI (US); Justin J. Song, Bloomfield Hills, MI (US)

(72) Inventors: Xubin Song, Bloomfield Hills, MI (US); Justin J. Song, Bloomfield Hills, MI (US)

(21) Appl. No.: 17/943,105

(22) Filed: Aug. 7, 2023

(51) Int. Cl. B60L 50/15; B60W 10/06; B60W 20/16

(52) U.S. Cl. CPC B60L 50/15; B60W 10/06; B60W 20/16; B60L 2200/36; B60L 2270/12; B60W 2300/125

(57) ABSTRACT

This invention develops an electrification solution to heavy commercial trucks, especially for the hard-to-electrify long haul trucking vehicles, agricultural and off-road equipment. The propulsion systems are dedicated to application of low carbon bio-fuels, ethanol and/or ethanol belndstocks, to replace diesel. Electric drives work as a propulsion system to maneuver the commercial vehicles while the on-board motive power systems provide electricity. The electricity generation system is ethanol agnostic from E0, E10, E15, E85 to E100. A vehicular powerplant system is composed of compact ethanol agnostic generators. Furthermore, the electricity is produced to optimally meet the dynamic power demands from the vehicle operations in a most efficient manner. The systematic architecture can minimize the energy losses among the electricity generation, transmission, storage, distribution, and utilization. This low carbon propulsion (LCP) can be an industrialization solution to significant reduction of emissions from conventional commercial vehicles, which are dominantly driven by diesel engines.

### 1. BACKGROUND OF THE INVENTION

This patent is dedicated to develop an innovative low carbon propulsion system for electrifying the medium- and heavy-duty trucks (MHDTs). At present, diesel and diesel powertrains are the mainstream motive power for MHDTs. In USA, there is only about 5% of the total vehicles as the MHDTs but these trucks create about 26% of GHG emissions according to the EPA data. In the other hand, bio-fuels feature low carbon or even carbon neutral application to light-duty vehicles (LDVs) [1]. Therefore, it is imperative to find out a propulsion technology with application of low/zero carbon fuels and energy to accomplish the de-dieselization for the hard-to-electrify MHDTs. The synergy of vehicle electrification and carbon-neutral bio-fuels can be a practical solution as low carbon propulsion (LCP) for commercial trucks.

### 2. SUMMARY OF THE INVENTION

Commercial vehicles operate under drastically varying workloads as well as different duty cycles. That means the motive power on commercial vehicles needs to deliver or produce a wide range of power and torque to meet the operation needs. The proposed range extender (RE) system can optimize the on-board powers to guarantee the best propulsion system efficiency so that the vehicle efficiency could be superior to conventional diesel powertrains.

### 3. BRIEF DESCRIPTION OF THE DRAWINGS

FIG. 1 is a configuration diagram of an exemplary range extender architecture based on multiple modules for commercial vehicles according to the present invention.

FIG. 2 illustrates the operation of the multiple-module based range extender system to meet the large undulating power demands of commercial vehicles according to the present invention.

FIG. 3 is a compositional view of an ethanol agnostic range extender (RE) module as an exemplary working mechanism according to the present invention.

### 4. DETAILED DESCRIPTION

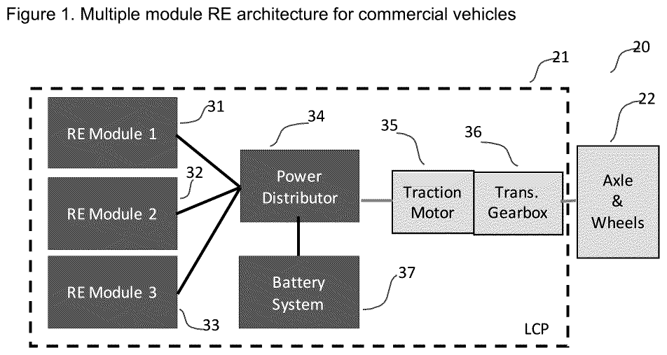

The exemplary system 20 has three RE modules 31,32, and 33, as shown in FIG. 1. However, for a more generic case, the purposive propulsion system can have more or less than three, dependent on the applications. These three RE modules 31,32, and 33, can be the same product or different. The design purpose is to optimize the delivered power through power distributor 34, traction motor 35, and transmission gearbox 36 to the axle/wheels 22 to optimally meet the demands from the vehicle drive.

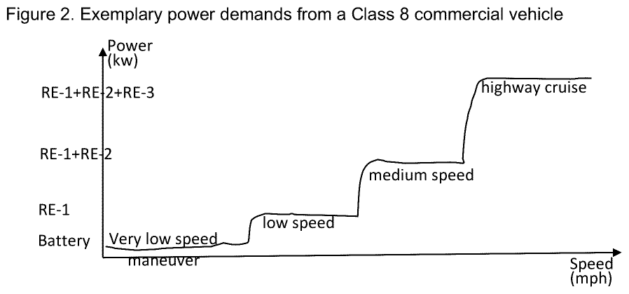

One simplified example is used to explain this optimal idea as shown in FIG. 2. A general rule is that while RE modules 31 (RE-1), 32 (RE-2), and 33 (RE-3) supply steady power in the most efficient manner to operate the vehicle, the battery system 37 can provide large transient or pulsation power for a short duration, for example, to launch a vehicle or to apply the regenerative braking. The energy management strategy is to minimize the electricity charging from RE modules 31,32, and 33, to the battery 37, while every RE module of 31,32, and 33 runs in its most efficient region per the BSFC map and generator efficiency. As shown in FIG. 2, Class 8 demands a large power while the vehicle drives on a highway. For instance, the power requirement can be around 150 KWs at 70 mph, while just a dozen of KWs may be needed for low speed maneuvers. If each RE of 31,32, and 33 has 50 KWs at its best efficiency, then the best way to run the range extender system is to run all three REs 31,32, and 33 to provide a total of 150 KWs, while only one RE of 31,32 or 33 (or just the battery system 37) may be needed to meet the lower power for very low speed maneuvers with the best energy efficiency usage.

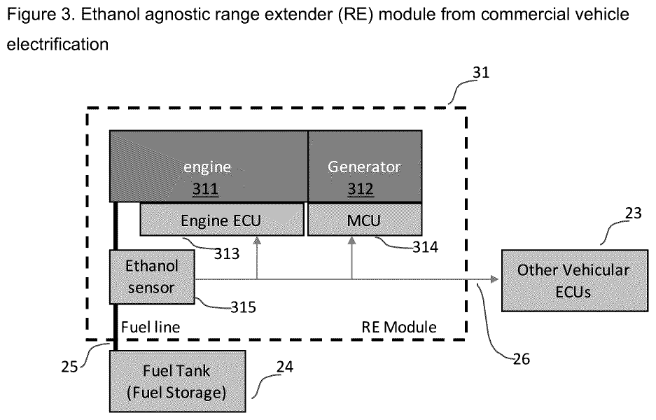

In USA, the existing fueling infrastructure can provide E0, E10, E15, and E85. These gasoline-ethanol blendstocks have different fuel properties [1], which can significantly affect the engine 311 performance. FIG. 3 presents a RE module design to use an ethanol sensor 315 (also called as “flex fuel sensor”) in the fuel line 25 to identify what kind of fuel blendstock is sent to the engine 311 from the fuel tank 22. This signal is shared on a vehicular electrical communication system 26 of such as CAN. Then the engine ECU 313 and generator MCU 314 can make optimal adjustment of ignition timing, thermal management, and other control strategies to deliver the best performance. The message from the ethanol sensor also can be used by any other vehicular ECUs 23 as needed. For instance, the signal can be used to predict/calculate the range, optimize the route with consideration of locations of the fueling stations, and log the accumulated usage of ethanol to the fleet managers for reporting purposes.

### REFERENCES

1. X. Song, J. J. Song, A. Khajepour, N. Zhang, “Progress overview on research of applicable bio-fuels and gasoline ICEs,” PMC2022 (Powertrain Modelling and Control, Testing, Mapping and Calibration Conference), Loughborough University, United Kingdom, 2022 September 5-7
2. Tran M-K, Bhatti A, Vrolyk R, Wong D, Panchal S, Fowler M, Fraser R., “A Review of Range Extenders in Battery Electric Vehicles: Current Progress and Future Perspectives.” World Electric Vehicle Journal. 2021; 12(2):54. https://doi.org/10.3390/ewvj12020054

BRIEF DESCRIPTION OF FURTHER CLAIMS

1. Furthermore, the engine in FIG. 3 can be the most popular “gasoline SI engine” as well as GCI engine (i.e., gasoline compression ignition).

2. Further claims can go to other forms of combustion engines [2] such as micro gas turbine, free-piston linear generator (FPLG), Stirling engine, rotary piston cylinder engine, opposed piston engine, Wankel engine, wave disk engine, and others. These combustion engines can accommodate using E0/10/15/85 as range extenders.

3. The system architecture is also applicable to other forms of range extenders based on combustion engines with application of other alternative fuels such as natural gas, propane, methanol, and hydrogen. In addition, application of SOFC (solid oxide fuel cell) and hydrogen fuel cell can derive very similar benefits from the system architecture as shown in FIG. 2.

4. In FIG. 1, the electric drive is shown as a single traction motor with a multi-speed gearbox. Further claims can be that the low carbon propulsion system can work out with electric axles, dual-motor based electric drive, and any other electric drives that can serve the commercial vehicles.

5. Variations of the range extender applications based on the above description are claimed accordingly, but not limited to.
